(19) United States
(12) Patent Application Publication
(10) Pub. No.: US 2018/0352280 A1
(43) Pub. Date: Dec. 6, 2018

(54) APPARATUS AND METHOD FOR PROGRAMMING ADVERTISEMENT

(71) Applicant: SAMSUNG SDS CO., LTD., Seoul (KR)

(72) Inventors: Jae-Ryeong LIM, Seoul (KR); Hyun-Joo JANG, Seoul (KR); Myung-Hoon KIM, Seoul (KR); Min-Beom CHO, Seoul (KR); Si-Myeong PARK, Seoul (KR); Song-yi HAN, Seoul (KR); Jin-Uke IM, Seoul (KR); Kyung-Ho PARK, Seoul (KR)

(73) Assignee: SAMSUNG SDS CO., LTD., Seoul (KR)

(21) Appl. No.: 15/992,400

(22) Filed: May 30, 2018

(30) Foreign Application Priority Data
May 31, 2017 (KR) 10-2017-0067937

(51) Int. Cl. H04N 21/262; H04N 21/234

(52) U.S. Cl. CPC H04N 21/26241; H04N 21/23418; H04N 21/23424

(57) ABSTRACT

Provided is an advertisement programming apparatus and advertisement programming method. The advertisement programming apparatus includes: a scene understanding information generator configured to generate scene understanding information including a keyword for each of a plurality of frame images, of a video content; a scene understanding information matcher configured to divide the video content into a plurality of scenes, and to match the scene understanding information with each of the plurality of scenes; and an advertisement scheduler configured to determine at least one advertisement content to be inserted into the video content, based on the scene understanding information matched with each of the plurality of scenes.

### CROSS-REFERENCE TO RELATED APPLICATION(S)

This application claims priority from Korean Patent Application No. 10-2017-0067937, filed on May 31, 2017, in the Korean Intellectual Property Office, the entire disclosure of which is incorporated herein by reference for all purposes.

### BACKGROUND

### 1. Field

The following description relates to technology for programming advertisements for insertion into a video content.

### 2. Description of the Related Art

There has been a continuous demand for an effective method of displaying advertisements in a video content during playback of the content in an Internet and mobile environment such as Internet Protocol Television (IPTV), Internet, smartphones, and the like.

In a general method of displaying advertisements, an advertisement provider provides advertisements without considering relevance to a playing video content at an insertion point determined by visual recognition based on their subjective criteria, thus providing advertisements that are not targeted to viewers.

The general method has drawbacks in that: an advertisement insertion point is determined subjectively; fatigue of an advertisement provider increases as the length of a video increases; and when advertisements, having no relevance to the content, are displayed in the video content, a viewer of the content may feel a sense of rejection toward the advertisements. Thus, it is highly likely that the viewer may stop viewing the video content or skip the advertisement contents, thereby resulting in a reduced effect of advertisement.

### SUMMARY

Provided is an advertisement programming apparatus and advertisement programming method.

In accordance with an aspect of the present disclosure, there is provided an advertisement programming apparatus, including: at least one processor configured to implement: a scene understanding information generator configured to generate scene understanding information including a keyword for each of a plurality of frame images, of a video content; a scene understanding information matcher configured to divide the video content into a plurality of scenes, and to match the scene understanding information with each of the plurality of scenes; and an advertisement scheduler configured to determine at least one advertisement content to be inserted into the video content, based on the scene understanding information matched with each of the plurality of scenes.

The at least one processor may be further configured to implement a scene change identifier configured to determine at least one scene change point in the video content, wherein the scene understanding information matcher may divide the video content into the plurality of scenes based on the at least one scene change point.

The at least one processor may be further configured to implement: a keyword expander configured to generate expanded keyword information, associated with the video content, the expanded keyword information including at least one from among an issue keyword and a neologism keyword, and configured to match the expanded keyword information with each of the plurality of scenes; and an scene understanding information storage configured to store the at least one scene change point, the scene understanding information matched with each of the plurality of scenes, and the expanded keyword information.

The scene understanding information generator may include: a scene understanding information keyword generator configured to generate a scene understanding keyword for each of the plurality of frame images of the video content, wherein the scene understanding keyword generated for a frame image of the video content, from among the plurality of frame images of the video content, is associated with at least one from among a caption, an object, a character, and a place which are included in the frame image; and a related keyword generator configured to generate a related keyword based on a word dictionary, the related keyword including at least one from among a keyword associated with a category to which the scene understanding keyword belongs, a related word, and a synonym for the scene understanding keyword, wherein the scene understanding information may include the scene understanding keyword and the related keyword.

The scene understanding information generator may further include a sentence generator configured to generate a sentence associated with each of the plurality of frame images of the video content by using at least one from among the scene understanding keyword and the related keyword, wherein the scene understanding information may further include the generated sentence.

The keyword expander may include: an expanded keyword ontology database configured to store an expanded keyword ontology, wherein the expanded keyword ontology is generated based on the issue keyword and the neologism keyword; and an expanded keyword matcher configured to extract the expanded keyword information, associated with the scene understanding information matched with each of the plurality of scenes, from the expanded keyword ontology, and configured to match the extracted expanded keyword information with each of the plurality of scenes.

The keyword expander may further include: an issue keyword collector configured to collect the issue keyword associated with the video content by crawling a web page related to the video content; and a neologism keyword collector configured to collect the neologism keyword from a neologism dictionary, wherein the expanded keyword ontology may be generated by using the collected issue keyword and neologism keyword.

The at least one advertisement content is a plurality of advertisement contents, and the advertisement scheduler may include: an advertisement information storage configured to store advertisement keyword information associated with each of the plurality of advertisement contents; and an advertisement content determiner configured to determine an advertisement content, from among the plurality of advertisement contents, to be inserted at the scene change point by comparing the scene understanding information and the expanded keyword information, which are matched with a scene, from among the plurality of scenes, before or after the scene change point, with the advertisement keyword information.

The scene change identifier may determine the scene change point based on at least one from among a noise, an edge, a color, a caption, and a face included in at least one frame image, from among the plurality of frame images of the video content.

The scene change identifier may include: an audio identifier configured to extract at least one section of the video content, based on a change in an audio signal amplitude of the video content; and an image identifier configured to determine the scene change point based on at least one of the noise, the edge, the color, the caption, and the face included in each frame image, from among of the plurality of frame images, within each of the at least one sections.

In accordance with another aspect of the present disclosure, there is provided an advertisement programming method, including: generating scene understanding information including a keyword for each of a plurality of frame images of a video content; dividing the video content into a plurality of scenes, and matching the scene understanding information with each of the plurality of scenes; and determining at least one advertisement content to be inserted into the video content, based on the scene understanding information matched with each of the plurality of scenes.

The advertisement programming method may further include determining at least one scene change point in the video content, wherein the dividing the video content into a plurality of scenes and matching of the scene understanding information may include dividing the video content into the plurality of scenes based on the at least one scene change point.

The advertisement programming method may further include generating expanded keyword information, associated with the video content, which includes at least one from among an issue keyword and a neologism keyword; and matching the expanded keyword information with each of the plurality of scenes.

The generating of the scene understanding information may include: generating a scene understanding keyword for each of the plurality of frame images of the video content, wherein the scene understanding keyword generated for a frame image of the video content, from among the plurality of frame images of the video content, is associated with at least one from among a caption, an object, a character, and a place which are included in the frame image; and generating a related keyword based on a word dictionary, the related keyword including at least one from among a keyword associated with a category to which the scene understanding keyword belongs, a related word, and a synonym for the scene understanding keyword, wherein the scene understanding information may include the scene understanding keyword and the related keyword.

The generating of the scene understanding information may further include generating a sentence associated with each of the plurality of frame images of the video content by using at least one from among the scene understanding keyword and the related keyword, wherein the scene understanding information may further include the generated sentence.

The generating of the expanded keyword information and matching the expanded keyword information with each of the plurality of scenes may include: extracting the expanded keyword information, associated with the scene understanding information matched with each of the plurality of scenes, from an expanded keyword ontology generated based on the issue keyword and the neologism keyword; and matching the extracted expanded keyword information with each of the plurality of scenes.

The generating of the expanded keyword information and matching the expanded keyword information with each of the plurality of scenes may further include: collecting the issue keyword associated with the video content by crawling a web page related to the video content; and collecting a neologism keyword from the neologism dictionary, wherein the expanded keyword ontology may be generated by using the collected issue keyword and neologism keyword.

The determining of the at least one advertisement content may include determining at least one advertisement content, from among a plurality of advertisement contents, to be inserted at the scene change point, by comparing the scene understanding information and the expanded keyword information, which are matched with a scene from among the plurality of scenes, before or after the scene change point, with advertisement keyword information, and wherein the advertisement keyword information is associated with each of the plurality of advertisement contents.

The determining of the scene change point may include determining the scene change point based on at least one from among a noise, an edge, a color, a caption, and a face included in at least one frame image, from among the plurality of frame images of the video content.

The determining of the scene change point may include: extracting at least one section of the video content, based on a change in an audio signal amplitude of the video content; and determining the scene change point based on at least one from among the noise, the edge, the color, the caption, and the face included in at least one frame image, from among the plurality of frame images, within each of the sections of the video content.

### BRIEF DESCRIPTION OF THE DRAWINGS

FIG. 1 is a diagram illustrating a configuration of an advertisement programming apparatus according to embodiments of the present disclosure.

FIG. 2 is a diagram illustrating a configuration of a scene change identifier 110 according to another embodiment of the present disclosure.

FIG. 3 is a diagram illustrating a configuration of a scene understanding information generator 120 according to an embodiment of the present disclosure.

FIG. 4 is a diagram illustrating a configuration of a keyword expander 140 according to an embodiment of the present disclosure.

FIG. 5 is a diagram illustrating a configuration of an advertisement scheduler 160 according to an embodiment of the present disclosure.

FIG. 6 is a flowchart illustrating an advertisement programming method according to an embodiment of the present disclosure.

FIG. 7 is a block diagram explaining an example of a computing environment which includes a computing device suitable for use in exemplary embodiments.

### DETAILED DESCRIPTION

Hereinafter, embodiments of the present disclosure will be described in detail with reference to the accompanying drawings. The following detailed description is provided for comprehensive understanding of methods, devices, and/or systems described herein. However, the methods, devices, and/or systems are merely examples, and the present disclosure is not limited thereto.

In the following description, a detailed description of well-known functions and configurations incorporated herein will be omitted when it may obscure the subject matter of the present disclosure. Further, the terms used throughout this specification are defined in consideration of the functions of the present disclosure, and can be varied according to a purpose of a user or manager, or precedent and so on. Therefore, definitions of the terms should be made on the basis of the overall context. It should be understood that the terms used in the detailed description should be considered in a description sense only and not for purposes of limitation. Any references to singular may include plural unless expressly stated otherwise. In the present specification, it should be understood that the terms, such as ‘including’ or ‘having,’ etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

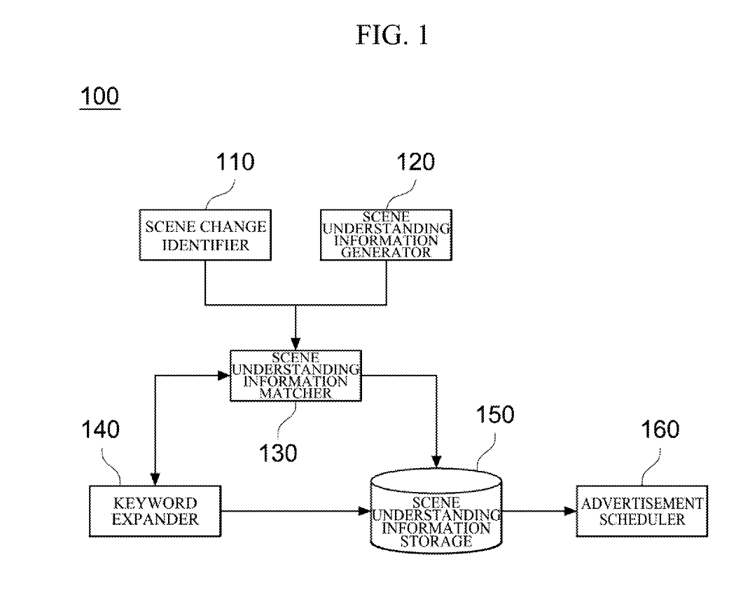

FIG. 1 is a diagram illustrating a configuration of an advertisement programming apparatus according to embodiments of the present disclosure.

Referring to FIG. 1, the advertisement programming apparatus 100 includes a scene change identifier 110, a scene understanding information generator 120, a scene understanding information matcher 130, a keyword expander 140, an scene understanding information storage 150, and an advertisement scheduler 160.

The advertisement programming apparatus 100 may perform programming of an interstitial advertisement in a video content by detecting a scene change point in the video content, by dividing the video content into scenes, and by inserting advertisement contents, which are highly relevant to each of the scenes, at each scene change point; and the advertisement programming apparatus 100 may include, for example, one or more servers.

The video content may be a content provided in a video-on-demand (VoD) service through IPTV, Internet websites, mobile applications, and the like.

The scene change identifier 110 may determine at least one scene change point in a video content.

Specifically, according to an embodiment of the present disclosure, the scene change identifier 110 may determine a scene change point based on at least one of a noise, an edge, a color, a caption, and a face which are included in each frame image of a video content.

For example, the scene change identifier 110 may calculate a Peak Signal-to-Noise Ratio (PSNR) of each frame image of a video content, and may determine a point, where the PSNR of a specific image frame is less than or equal to a predetermined reference value, to be a scene change point.

In another example, the scene change identifier 110 may detect edges in each frame image of a video content, and may determine a point, where a change in the number of edges between frame images is greater than or equal to a predetermined reference value, to be a scene change point. In this case, the edges may be detected by using various known edge detection algorithms. Specifically, the scene change identifier 110 may detect edges, for example, in a region of interest of each frame image, and then may determine a point, where a change in the number of the detected edges is greater than or equal to a reference value, to be a scene change point. In this case, the region of interest may be a region predetermined by a user. For example, in the case where a video content is an entertainment program in which a caption associated with a current scene or an episode is displayed at the upper left end of an image, and the caption at the position is changed when the scene or the episode is changed, a user may determine the upper left end region to be a region of interest. In this case, if a caption displayed in a region of interest is changed, the number of the detected edges is also changed significantly, which are detected in a region of interest of each frame image before and after the caption is changed, thereby enabling easy detection of a scene change point.

In another example, the scene change identifier 110 may extract a caption from a region of interest of each frame image of a video content, and may determine a point, where the extracted caption is changed, to be a scene change point. In this case, a caption may be extracted by using, for example, Optical Character Recognition (OCR). Specifically, as described above, in the case where a video content is an entertainment program in which a caption associated with a current scene or an episode is displayed at the upper left end of an image, the upper left end region may be determined to be a region of interest; and the scene change identifier 110 may determine, as a scene change point, a point where a similarity between captions extracted from a region of interest of each frame image is greater than or equal to a predetermined reference value. In this case, the similarity between captions may, be calculated by using, for example, Levenshtein Distance.

In yet another example, the scene change identifier 110 may generate a color histogram for each frame image of a video content, and may determine a point, where a change in the color histogram between frame images is greater than or equal to a predetermined reference value, to be a scene change point, Specifically, the scene change identifier 110 may generate, for example, a Hue-Lightness-Saturation (HSI) color histogram for each frame image, and may determine a point, where a distance between color histograms of frame images is greater than or equal to a reference value, to be a scene change point. In this case, the distance between color histograms may be calculated by, for example, Bhattacharyya. Distance. Specifically, in the case of images of a sporting event such as a football game, the images are mostly game images, such that a color histogram change between frame images is not significant. However, in replay scenes including a scoring scene, a foul scene, and the like, a graphic effect is generally displayed prior to changing to the replay scenes. In this case, when a scene is changed following a graphic effect, the color histogram is significantly changed, such that a scene change point may be easily detected.

In still another example, the scene change identifier 110 may recognize a face included in each frame image of a video content, and may determine a point, where a character is changed, to be a scene change point. In this case, various known face recognition algorithms may be used for face recognition.

The method of determining a scene change point is not limited to the foregoing. That is, the scene change identifier 110 may detect a scene change point by combining one or more of the above methods according to a genre of a video content; and depending on embodiments, the scene change identifier 110 may determine a scene change point by further using a change in the number of faces detected in each frame image, a change in skin color distribution, and the like, in addition to the aforementioned methods.

According to another embodiment of the present disclosure, the scene change identifier 110 may determine one or more sections to be analyzed based on an audio signal of a video content, and may determine a scene change point by analyzing frame images in each of the determined sections to be analyzed.

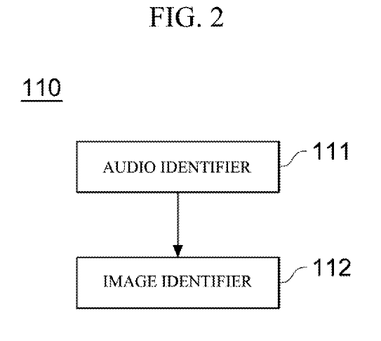

Specifically, FIG. 2 is a diagram illustrating a configuration of the scene change identifier 110 according to another embodiment of the present disclosure.

Referring to FIG. 2, the scene change identifier 110 includes an audio identifier 111 and an image identifier 112.

The audio identifier 111 may extract one or more sections to be analyzed in a video content based on a change in an audio signal amplitude. In this case, the analysis section to be analyzed may include, for example, at least one of a mute section, a peak section, and a sound effect section.

Specifically, according to an embodiment of the present disclosure, the audio identifier 111 may extract, as a mute section, a section in which an audio signal amplitude remains at a level less than or equal to a predetermined reference value for a predetermined period of time or longer. For example, the audio identifier 111 may extract, as a mute section, a section in which an audio signal amplitude remains at a level less than or equal to −20 dB for one second or longer. In this case, depending on embodiments, if the number of the extracted mute sections is less than a predetermined number (e.g., 50), the audio identifier 111 may increase the reference value by 1 dB until the predetermined number of mute sections are extracted.

Further, according to an embodiment of the present disclosure, the audio identifier 111 may extract, as a peak section, a section in which an audio signal amplitude remains at a level greater than or equal to a predetermined reference value for a predetermined period of time or longer. For example, the audio identifier 111 may extract, as the peak section, a section which an audio signal amplitude remains at a level greater than or equal to 10 dB for one second or longer. In this case, depending on embodiments, if the number of the extracted peak sections is less than a predetermined number (e.g., 50), the audio identifier 111 may reduce a reference value by 1 dB until the predetermined number of peak sections are extracted.

In addition, according to an embodiment of the present disclosure, if an audio signal having a specific amplitude is repeated, the audio identifier 111 may extract, as a sound effect section, a section having the audio signal amplitude. For example, the audio identifier 111 may divide the amplitude of an audio signal between −20 dB and 20 dB in units of 1 dB, and may extract a section of each audio signal amplitude; and among the extracted sections, if the number of sections having a specific audio amplitude is greater than or equal to a predetermined value, the audio identifier 111 may extract the sections having the specific audio signal amplitude as a sound effect section.

The image identifier 112 may extract a scene change point by analyzing frame images included in each of the sections to be analyzed which are extracted by the audio identifier 111. In this case, the scene change point may be extracted by using various methods as described above.

According to the embodiment illustrated in FIG. 2, the image identifier 112 extracts a scene change point from each of the sections to be analyzed, instead of the entire video content, such that a calculation amount and time required for extracting a scene change point may be reduced.

Referring back to FIG. 1, the scene understanding information generator 120 may generate scene understanding information for each frame image of a video content. In this case, the scene understanding information may include scene understanding keywords, and related keywords for each of the scene understanding keywords.

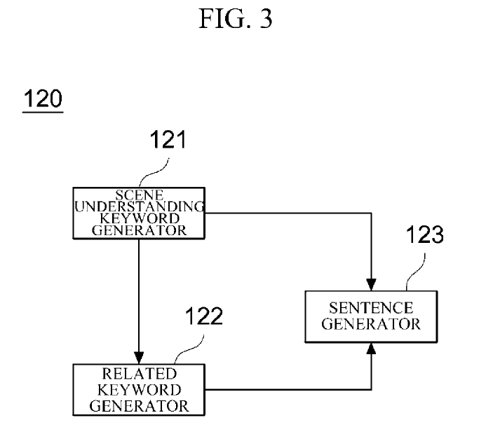

Specifically, FIG. 3 is a diagram illustrating a configuration of the scene understanding information generator 120 according to an embodiment of the present disclosure.

Referring to FIG. 3, the scene understanding information generator 120 includes a scene understanding keyword generator 121, a related keyword generator 122, and a sentence generator 123.

The scene understanding keyword generator 121 may generate scene understanding keywords for each frame image of a video content. In this case, the scene understanding keywords may include keywords associated with at least one of a caption, an object, a character, and a place which are included in each frame image.

Specifically, according to an embodiment of the present disclosure, the scene understanding keyword generator 121 may recognize a caption included in each frame image by using Optical Character Recognition (OCR), and may extract keywords from the recognized caption. In this case, the keywords may be extracted by performing, for example, processes such as morpheme analysis, Named Entity Recognition, processing of a stop word, and the like, of the recognized caption.

Further, according to an embodiment of the present disclosure, the scene understanding keyword generator 121 may generate a scene understanding keyword associated with each frame image, by using one or more pre-generated keyword generating models. In this case, each keyword generating model may be generated by machine learning using, as training data, pre-collected images and keywords associated with each of the images. For example, the keyword generating model may be generated by using as training data pre-collected images of actors and keywords (e.g., name, role, gender, etc.) associated with each of the actors, or may be generated by using as training data pre-collected images of various places (e.g., airport, airplane, train, hospital, etc.) and keywords associated with each of the places.

The related keyword generator 122 may generate one or more related keywords for each scene understanding keyword generated by the scene understanding keyword generator 121, based on a pre-built word dictionary. In this case, the related keyword may include a keyword indicating a category to which a scene understanding keyword belongs, and a related word and a synonym for each scene understanding keyword.

The sentence generator 123 may generate a sentence associated with each frame image by using the scene understanding keyword generated for each frame image and the related keyword. Specifically, the sentence generator 123 may generate a sentence associated with each frame image by using the meaning of each of the scene understanding keyword and related keyword based on the word dictionary. In this case, the sentences may be generated by using various known sentence generating algorithms.

Referring back to FIG. 1, the scene understanding information matcher 130 divides a video content into scenes based on the scene change point determined by the scene change identifier 110, and matches the scene understanding information, generated by the scene understanding information generator 120, with each of the scenes.

Specifically, the scene understanding information matcher 130 may match the scene understanding information, associated with frame images in each of the scenes obtained by division based on the scene change point, with scene understanding information for each of the scenes.

The keyword expander 140 may generate expanded keyword information which includes at least one of an issue keyword, associated with each of the scenes obtained by division based on the scene change point, and a neologism keyword.

According to an embodiment of the present disclosure, the keyword expander 140 may generate an expanded keyword associated with each of the scenes of a video content, based on issue keywords collected from web pages related to the video content and neologism keywords collected from a neologism dictionary.

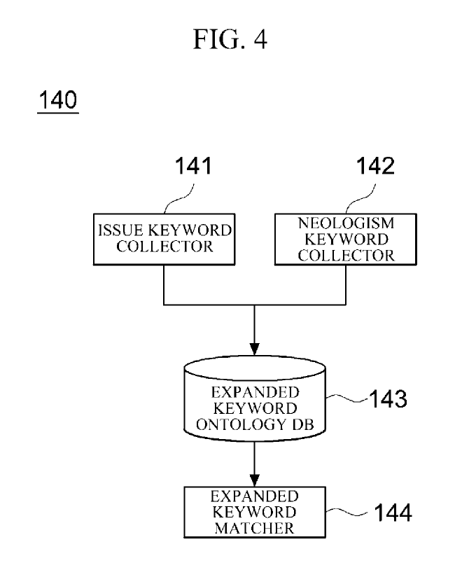

Specifically, FIG. 4 is a diagram illustrating a configuration of the keyword expander 140 according to an embodiment of the present disclosure.

Referring to FIG. 4, the keyword expander 140 includes an issue keyword collector 141, a neologism keyword collector 142, an expanded keyword ontology database (DB) 143, and an expanded keyword matcher 144.

The issue keyword collector 141 may extract an issue keyword by crawling a web page related to a video content. In this case, the web page may include social media posts, news articles, and the like. Specifically, the issue keyword collector 141 may crawl web pages related to a video content based on, for example, a title of a video content and a number of episodes of a video content, and may extract issue keywords from the crawled web pages. In this case, the issue keyword collector 141 may extract issue keywords according to various rules predetermined by a user, such as texts having a high frequency of appearance in the crawled web pages, texts included in the titles of web pages, and the like.

The neologism keyword collector 142 may collect neologism keywords from a neologism dictionary. In this case, the neologism dictionary may be, for example, a database provided from an external source such as the National institute of the Korean Language and the like.

The expanded keyword ontology DB 143 may store an expanded keyword ontology generated by using the issue keywords collected by the issue keyword collector 141, and the neologism keywords collected by the neologism keyword collector 142. Specifically, the expanded keyword ontology may be generated based on a semantic relationship among the issue keywords collected by the issue keyword collector 141, the neologism keywords collected by the neologism keyword collector 143, and keywords provided by a word dictionary.

The expanded keyword matcher 144 may extract, as an expanded keyword, an issue keyword and a neologism keyword, each associated with the scene understanding information matched with each of the scenes, from the expanded keyword ontology DB 143, and may match the extracted expanded keyword with each of the scenes.

Referring back to FIG. 1, the scene understanding information storage 150 may store the scene change point, the scene understanding information matched with each of the scenes obtained by division based on the scene change point, and the expanded keyword information.

The advertisement scheduler 160 may determine an advertisement to be inserted at each scene change point, based on the scene change point, the scene understanding information associated with each of the scenes, and the expanded keyword information which are stored in the scene understanding information storage 150.

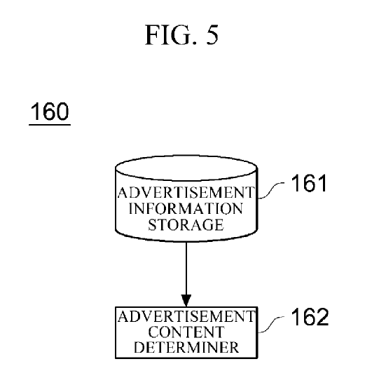

Specifically, FIG. 5 is a diagram illustrating a configuration of the advertisement scheduler 160 according to an embodiment of the present disclosure.

Referring to FIG. 5, the advertisement scheduler 160 includes an advertisement information storage 161 and an advertisement content determiner 162.

The advertisement information storage 161 stores advertisement keyword information associated with one or more advertisement contents. In this case, the advertisement keyword information may include keywords associated with each advertisement content. For example, the advertisement keyword may include various keywords associated with a product name, a product type, a selling company, an advertisement model, and the like; and the advertisement keyword information may be, for example, provided in advance by an advertiser.

The advertisement content determiner 162 may compare the scene understanding information and the expanded keyword information, which are matched with a scene before or after each scene change point stored in the scene understanding information storage 150, with advertisement keyword information associated with each advertisement content; and may determine an advertisement content having highly relevance as an advertisement content to be inserted at each scene change point. For example, the advertisement content determiner 162 may compare the scene understanding information and the expanded keyword information, which are matched with a scene before or after each scene change point, with the advertisement keyword information associated with each advertisement content; and may determine an advertisement content, which has a high concordance rate of keywords, as an advertisement content to be inserted at each scene change point.

In one embodiment, the scene change identifier 110, the scene understanding information generator 120, the scene understanding information matcher 130, the keyword expander 140, the scene understanding information storage 150, and the advertisement scheduler 160, which are illustrated in FIG. 1, may be implemented on one or more computing devices including one or more processors and a computer-readable recording medium connected to the one or more processors. The computer-readable recording medium may be provided inside or outside the processor, and may be connected to the processor by using various well-known methods. The processor in the computing devices may control each computing device to operate according to the exemplary embodiments described herein. For example, the processor may execute one or more instructions stored on the computer-readable recording medium. When being executed by the processor, the one or more instructions stored on the computer-readable recording medium may cause the computing device to perform operations according to the exemplary embodiments described in the present disclosure.

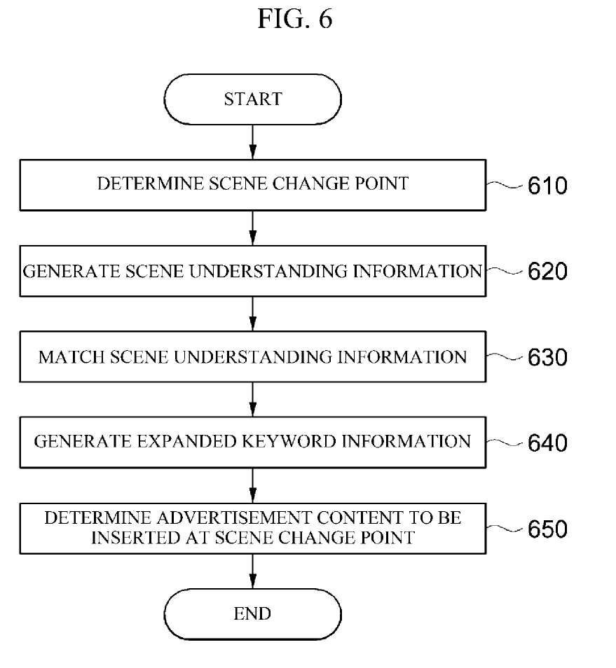

FIG. 6 is a flowchart illustrating an advertisement programming method according to an embodiment of the present disclosure.

The method illustrated in FIG. 6 may be performed by, for example, the advertisement programming apparatus 100 illustrated in FIG. 1.

Referring to FIG. 6, the advertisement programming apparatus 100 determines at least one scene change point ent in 610.

In this case, according to an embodiment of the present disclosure, the advertisement programming apparatus 100 may determine the scene change point based on at least one of a noise, an edge, a color, a caption, and a face which are included in each frame image of a video content.

Further, according to an embodiment of the present disclosure, the advertisement programming apparatus 100 may extract one or more sections to be analyzed based on a change in an audio signal amplitude of a video content, and may determine a scene change point based on at least one of a noise, an edge, a color, a caption, and a face which are included in a frame image within each of the extracted sections to be analyzed.

Then, the advertisement programming apparatus 100 may generate scene understanding information which includes a scene understanding keyword associated with each frame image of a video content and a related keyword for the scene understanding keyword in 620.

In this case, according to an embodiment of the present disclosure, the scene understanding keyword may include keywords associated with at least one of a caption, an object, a character, and a place.

Further, according to an embodiment of the present disclosure, the related keyword may include at least one of a keyword associated with a category to which a scene understanding keyword belongs, and a related word and a synonym for the scene understanding keyword, in which the related keyword may be generated based on a word dictionary.

In addition, according to an embodiment of the present disclosure, the advertisement programming apparatus 100 may generate a sentence associated with each frame image by using the scene understanding keyword for each frame image and the related keyword, in which case the scene understanding information for each frame image may further include the generated sentence.

Subsequently, the advertisement programming apparatus 100 divides a video content into scenes based on a scene change point, and matches scene understanding information, which is generated for each frame image, with each of the scenes in 630.

Next, the advertisement programming apparatus 100 generates expanded keyword information which includes at least one of an issue keyword associated with each of the scenes and a neologism keyword, and matches the generated expanded keyword information with each of the scenes in 640.

In this case, according to an embodiment of the present disclosure, the advertisement programming apparatus 100 may extract the expanded keyword information, which is associated with the scene understanding information matched with each of the scenes, from an expanded keyword ontology generated based on the issue keywords associated with a video content and the neologism keywords collected from a neologism dictionary.

Then, the advertisement programming apparatus 100 determines an advertisement content to be inserted at each scene change point based on the scene change point, the scene understanding information matched with each of the scenes, and the expanded keyword information in 650.

Specifically, according to an embodiment of the present disclosure, advertisement programming apparatus 100 may determine an advertisement content to be inserted at the scene change point, by comparing the scene understanding information and the expanded keyword information, which are matched with a scene before or after the scene change point, with the advertisement keyword information which is associated with each of one or more advertisement contents.

While the flowchart illustrated in FIG. 6 shows that the method is divided into a plurality of operations, at least some of the operations nay be performed in different order, may be combined to be performed concurrently, may be omitted, may be performed in sub-operations, or one or more operations not shown in the drawing may be added and performed.

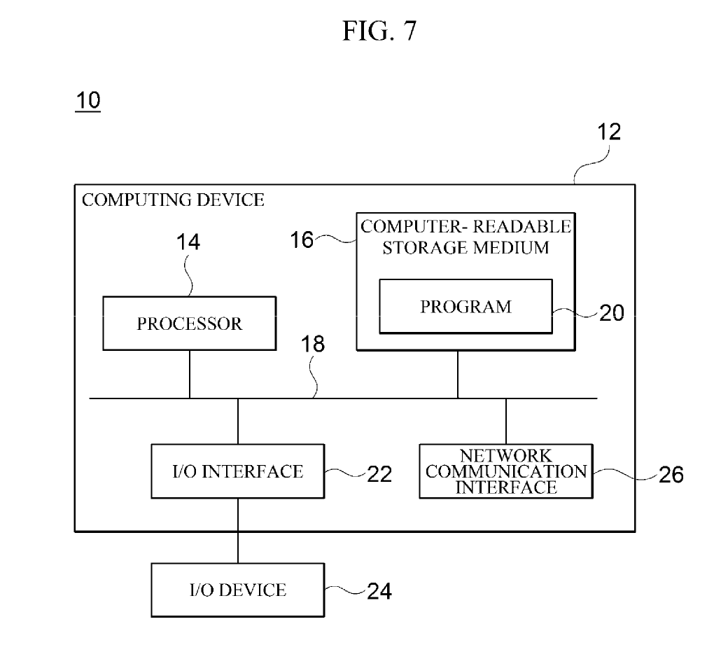

FIG. 7 is a block diagram explaining an example of a computing environment which includes a computing device suitable for use in exemplary embodiments. In the illustrated embodiment, each component may have a different function or capability from those described below, and other components may be further included in addition to the components which will be described below.

The computing environment 10 includes a computing device 12. In one embodiment, the computing device 12 may be, for example, one or more components, such as the scene change identifier 110, the scene understanding information generator 120, the scene understanding information matcher 130, the keyword expander 140, the scene understanding information storage 150, and the advertisement scheduler 160, which are included in the advertisement programming apparatus 100.

The computing device 12 includes at least one processor 14, a computer-readable storage medium 16, and a communication bus 18. The processor 14 may control the computing device 12 to operate according to the above-described exemplary embodiments. For example, the processor 14 may execute one or more programs stored on the computer-readable storage medium 16. The one or more programs may include one or more computer-executable instructions, which when being executed by the processor 14, may cause the computing device 12 to perform operations according to the exemplary embodiments.

The computer-readable storage medium 16 stores computer-executable instructions, program codes, program data, and/or other suitable forms of information. The programs 20 stored on the computer-readable storage medium 16 may include a set of instructions executable by the processor 14. In one embodiment, the computer-readable storage medium 16 may be a memory (volatile or non-volatile memory such as a random access memory (RAM), or a suitable combination thereof), one or more magnetic disc storage devices, optical disk storage devices, flash memory devices, and other forms of storage media accessible by the computing device 12 and capable of storing desired information, or any suitable combination thereof.

The communication bus 18 interconnects various components of the computing device 12 including the processor 14 and the computer-readable storage medium 16.

The computing device 12 may further include one or more input/output (110) interfaces 22 to provide interfaces for one or more I/O devices 24, and one or more network cation interfaces 26. The I/O interface 22 and the network communication interface are connected to the communication bus 18. The I/O device 24 may be connected to other components of the computing device 12 through the I/O interface 22. The illustrative I/O device 24 may include a pointing device (e.g., mouse, trackpad, etc.), a keyboard, a touch input device (e.g., touch pad, touch screen, etc.), a voice u d input device, input devices such as various types of sensor devices and/or a photographing device, and/or output devices such as a display device, a printer, a speaker, and/or a network card. The illustrative I/O device 24 may be included in the computing device 12 as a component of the computing device 12, or may be connected to the co device 12 as a separate device distinct from the computing device 12.

According to the embodiments of the present disclosure, advertisements, which are highly relevant to the scenes of a video content, may be inserted at an appropriate insertion the video content, thereby reducing viewers' rejection toward advertisements, and improving the effect of advertisement.

Although representative embodiments of the present disclosure have been described in detail, it should be understood by those skilled in the art that various modifications to the aforementioned embodiments can be made without departing from the spirit and scope of the present disclosure. Thus, the scope of the present disclosure should be defined by the appended claims and their equivalents, and is not restricted or limited by the foregoing detailed description.

What is claimed is:

1. An advertisement programming apparatus, comprising:
at least one processor configured to implement:
a scene understanding information generator configured to generate scene understanding information including a keyword for each of a plurality of frame images, of a video content;
a scene understanding information matcher configured to divide the video content into a plurality of scenes, and to match the scene understanding information with each of the plurality of scenes; and
an advertisement scheduler configured to determine at least one advertisement content to be inserted into the video content, based on the scene understanding information matched with each of the plurality of scenes.

2. The apparatus of claim 1, wherein the at least one processor is further configured to implement a scene change identifier configured to determine at least one scene change point in the video content,
wherein the scene understanding information matcher divides the video content into the plurality of scenes based on the at least one scene change point.

3. The apparatus of claim 2, wherein the at least one processor is further configured to implement:
a keyword expander configured to generate expanded keyword information, associated with the video content, the expanded keyword information including at least one from among an issue keyword and a neologism keyword, and configured to match the expanded keyword information with each of the plurality of scenes; and
a scene understanding information storage configured to store the at least one scene change point, the scene understanding information matched with each of the plurality of scenes, and the expanded keyword information.

4. The apparatus of claim 1, wherein the scene understanding information generator comprises:
a scene understanding information keyword generator configured to generate a scene understanding keyword for each of the plurality of frame images of the video content, wherein the scene understanding keyword generated for a frame image of the video content, from among the plurality of frame images of the video content, is associated with at least one from among a caption, an object, a character, or a place which are included in the frame image; and
a related keyword generator configured to generate a related keyword based on a word dictionary, the related keyword including at least one from among a keyword associated with a category to which the scene understanding keyword belongs, a related word, and a synonym for the scene understanding keyword,
wherein the scene understanding information includes the scene understanding keyword and the related keyword.

5. The apparatus of claim 4, wherein the scene understanding information generator further comprises a sentence generator configured to generate a sentence associated with each of the plurality of frame images of the video content by using at least from among of the scene understanding keyword and the related keyword,
wherein the scene understanding information further includes the generated sentence.

6. The apparatus of claim 3, wherein the keyword expander comprises:
an expanded keyword ontology database configured to store an expanded keyword ontology, wherein the expanded keyword ontology is generated based on the issue keyword and the neologism keyword; and
an expanded keyword matcher configured to extract the expanded keyword information, associated with the scene understanding information matched with each of the plurality of scenes, from the expanded keyword ontology, and configured to match the extracted expanded keyword information with each of the plurality of scenes.

7. The apparatus of claim 6, wherein the keyword expander further comprises:
an issue keyword collector configured to collect the issue keyword associated with the video content by crawling a web page related to the video content; and
a neologism keyword collector configured to collect the neologism keyword from a neologism dictionary,
wherein the expanded keyword ontology is generated by using the collected issue keyword and neologism keyword.

8. The apparatus of claim 3, wherein the at least one advertisement content is a plurality of advertisement contents, and
wherein the advertisement scheduler comprises:
an advertisement information storage configured to store advertisement keyword information associated with each of the plurality of advertisement contents; and
an advertisement content determiner configured to determine an advertisement content, from among the plurality of advertisement contents, to be inserted at the scene change point by comparing the scene understanding information and the expanded keyword information, which are matched with a scene, from among the plurality of scenes, before or after the scene change point, with the advertisement keyword information.

9. The apparatus of claim 2, wherein the scene change identifier determines the scene change point based on at least one from among a noise, an edge, a color, a caption, and a face included in at least one frame image, from among the plurality of frame images of the video content.

10. The apparatus of claim 9, wherein the scene change identifier comprises:
an audio identifier configured to extract at least one section of the video content, based on a change in an audio signal amplitude of the video content; and
an image identifier configured to determine the scene change point based on at least one of the noise, the edge, the color, the caption, and the face included in each frame image, from among of the plurality of frame images, within each of the at least one sections.

11. An advertisement programming method, comprising:
generating scene understanding information including a keyword for each of a plurality of frame images of a video content;
dividing the video content into a plurality of scenes, and matching the scene understanding information with each of the plurality of scenes; and
determining at least one advertisement content to be inserted into the video content, based on the scene understanding information matched with each of the plurality of scenes.

12. The method of claim 11, further comprising determining at least one scene change point in the video content,
wherein the dividing the video content into a plurality of scenes and matching of the scene understanding information comprises dividing the video content into the plurality of scenes based on the at least one scene change point.

13. The method of claim 12, further comprising:
generating expanded keyword information, associated with the video content, which includes at least one from among an issue keyword and a neologism keyword; and
matching the expanded keyword information with each of the plurality of scenes.

14. The method of claim 11, wherein the generating of the scene understanding information comprises:
generating a scene understanding keyword for each of the plurality of frame images of the video content, wherein the scene understanding keyword generated for a frame image of the video content, from among the plurality of frame images of the video content, is associated with at least one from among a caption, an object a character, and a place which are included in the frame image; and
generating a related keyword based on a word dictionary, the related keyword including at least one from among a keyword associated with a category to which the scene understanding keyword belongs, a related word, and a synonym for the scene understanding keyword,
wherein the scene understanding information includes the scene understanding keyword and the related keyword.

15. The method of claim 14, wherein the generating of the scene understanding information further comprises generating a sentence associated with each of the plurality of frame images of the video content by using at least one from among the scene understanding keyword and the related keyword,
wherein the scene understanding information further includes the generated sentence.

16. The method of claim 13, wherein the generating of the expanded keyword information and matching the expanded keyword information with each of the plurality of scenes comprises:
extracting the expanded keyword information, associated with the scene understanding information matched with each of the plurality of scenes, from an expanded keyword ontology generated based on the issue keyword and the neologism keyword; and
matching the extracted expanded keyword information with each of the plurality of scenes.

17. The method of claim 16, wherein the generating of the expanded keyword information and matching the expanded keyword information with each of the plurality of scenes further comprises:
collecting the issue keyword associated with the video content by crawling a web page related to the video content; and
collecting the neologism keyword from a neologism dictionary,
wherein the expanded keyword ontology is generated by using the collected issue keyword and neologism keyword.

18. The method of claim 13, wherein the determining of the at least one advertisement content comprises determining at least one advertisement content, from among a plurality of advertisement contents, to be inserted at the scene change point, by comparing the scene understanding information and the expanded keyword information, which are matched with a scene from among the plurality of scenes, before or after the scene change point, with advertise keyword information, and
wherein the advertisement keyword information is associated with each of the plurality of advertisement contents.

19. The method of claim 12, wherein the determining of the scene change point comprises determining the scene change point based on at least one from among a noise, an edge, a color, a caption, and a face included in at least one frame image, from among the plurality of frame images of the video content.

20. The method of claim 19, wherein the determining of the scene change point comprises:
extracting at least one section of the video content, based on a change in an audio signal amplitude of the video content; and
determining the scene change point based on at least one from among the noise, the edge, the color, the caption, and the face included in at least one frame image, from among the plurality of frame images, within each of the sections of the video content.
